(19) United States
(12) Patent Application Publication
(10) Pub. No.: US 2006/0072444 A1
(43) Pub. Date: Apr. 6, 2006

(54) Marked article and method of making the same

(76) Inventors: David B. Engel, Clifton Park, NY (US); David G. Gascoyne, Scehectady, NY (US); Vandita Pai-Paranjape, Evansville, IN (US); Radislav A. Potyrailo, Niskayuna, NY (US); Philippe Schottland, Evansville, IN (US); William D. Smith, Schenectady, NY (US); Micah Sakiestewa Sze, Albany, NY (US); Marc B. Wisnudel, Clifton Park, NY (US); Pingfan Wu, Niskayuna, NY (US)

Correspondence Address: CANTOR COLBURN LLP - GE PLASTICS - SMITH, 55 GRIFFIN RD SOUTH, BLOOMFIELD, CT, 06002, US

(21) Appl. No.: 10/952,653

(22) Filed: Sep. 29, 2004

(51) Int. Cl. G11B 7/24

(52) U.S. Cl. 369/275.1; 369/272.1

(57) ABSTRACT

A storage medium can comprise a substrate, a reflective layer disposed on a side of the substrate, and data. The substrate can comprise a thermoplastic and a light-mark formed from at least a portion of light-marking additive mixed with the thermoplastic, wherein an optical property of the light-marking additive at an optical drive read wavelength can change due to being contacted with a mark wavelength. A method for using a storage medium can comprise directing a reading device to detect an inspection area of the storage medium, and wherein the inspection area on an authentic medium has a light-mark in a substrate of the storage medium that forms an optically induced signature. The optically induced signature can be converted to a digital identification signature and the digital identification signature can be verified for authenticity.

### BACKGROUND

A major problem confronting the various makers and users of non-recordable and recordable data storage media such as compact discs (CD), digital versatile discs (DVD), enhanced video discs (EVD), recordable compact discs (CD-R) and recordable digital versatile discs (DVD-R), is the unauthorized reproduction or copying of information by unauthorized manufacturers, sellers, and/or users. Such unauthorized reproduction or duplication of data storage media is often referred to as piracy. Piracy may occur in a variety of ways, including consumer level piracy at the point of end use as well as wholesale duplication of data, substrate and anti-piracy information at the commercial level. Regardless of the manner, piracy of data storage media deprives legitimate digital content providers and manufacturers of significant revenue and profit.

Attempts to stop piracy at the consumer level have included the placement of electronic anti-piracy signals on information carrying substrates along with the information sought to be protected. The machine readers and players of such data storage media are configured to require the identification of such anti-piracy signals prior to allowing access to the desired information. Theoretically, consumer level duplications are unable to reproduce these electronic anti-piracy signals on unauthorized copies and hence result in duplicates and copies that are unusable.

However, numerous technologies to thwart such consumer level anti-piracy technologies have been and continue to be developed. Moreover, commercial level duplications have evolved to the point that unauthorized duplicates may now contain the original electronic anti-piracy circuit, code, etc. For example, commercial level duplication methods include pit copying, radio frequency (RF) copying, “bit to bit” copying and other mirror image copying techniques which result in the placement of the anti-piracy signal on the information carrying substrate of the duplicate along with the information sought to be protected. Other technologies commonly used by hackers include the modification of the computer code in order to remove anti-piracy (also referred to as copy-protection or copy-proofing) features and enable unlimited access to the data.

It would be desirable to have a data storage media that can be easily identified as being authentic or pirated. Hence, it is becoming increasingly important to serialize production goods for purposes of tracking and inventory control. The serialization can be performed at the individual item scale, package scale, pallet scale, etc. and typically is in the form of barcodes containing production dates, expiry dates, company logos or other information. In the specific case of the optical disc industry, multiple copies of discs containing software programs, games, music, movies, etc. are regularly produced.

It would be useful to have a serial number or unique identifier that: is compatible with multiple media types (e.g. CD-audio, DVD video, CD-rom, DVD-rom, HD-DVD, BD, etc.), is compatible with low-cost manufacturing techniques (integratable into the replication lines, compatible with standard cycle times of replication), and that can be read by a consumer (legacy) drive (e.g., a commercially-available (unmodified or ordinary) optical drive).

### SUMMARY

Disclosed herein are optical storage media, methods of making and using optical storage media. In one embodiment, a storage medium can comprise a substrate, a reflective layer disposed on a side of the substrate, and data. The substrate can comprise a thermoplastic and a light-mark formed from at least a portion of light-marking additive mixed with the thermoplastic, wherein an optical property of the light-marking additive at an optical drive read wavelength can change due to being contacted with a mark wavelength.

In one embodiment, the method for making a storage medium, can comprising: combining a thermoplastic with a light-marking additive to form a blend, injection molding the blend to form a substrate, disposing a reflective layer on the substrate to form a medium, and exposing a portion of the substrate to a marking wavelength to form a light-mark in the substrate.

In one embodiment, a method for using a storage medium can comprise directing a reading device to detect an inspection area of the storage medium, and wherein the inspection area on an authentic medium has a light-mark in a substrate of the storage medium that forms an optically induced signature. The optically induced signature can be converted to a digital identification signature and the digital identification signature can be verified for authenticity.

The above described and other features are exemplified by the following figures and detailed description.

### BRIEF DESCRIPTION OF THE DRAWINGS

Refer now to the figures, which are exemplary embodiments, and wherein the like elements are numbered alike.

FIGS. 1-6 are exemplary illustrations of possible focused laser mark profiles within the substrate.

FIG. 7 is an illustration of one embodiment of a laser marking system using a galvo mirror.

FIG. 8 is a schematic of one embodiment of a laser marking system using a modified drive.

FIG. 9 is a graphical comparison of optical discs comprising dye1 doped polycarbonate, with and without UV exposure.

FIG. 10 is a graphical comparison of optical discs comprising dye2 doped polycarbonate, with and without UV exposure.

FIG. 11 is a graphical representation of K-probe results showing location of P0 errors as a function of logical block addresses, before and after bleaching the methylene blue coating disposed on the disc.

FIG. 12 illustrates an error signature of a light-marked CD comprising polycarbonate doped with crystal violet lactone and a photoacid generator.

FIG. 13 is a top view of a DVD spotted with an alcohol solution containing black pigments.

FIG. 14 is a graphical representation of K-probe results for the DVD of FIG. 13 showing the distribution and magnitude of PI errors as a function of logic block address.

FIG. 15 is a top view of a DVD spotted with an alcohol solution containing black pigments.

FIG. 16 is a graphical representation of K-probe results for the DVD of FIG. 13 showing the distribution and magnitude of PI errors as a function of logic block address.

FIG. 17 is a graphical representation of C1 errors (measured using K-probe) for a DVD spotted with an alcohol solution containing black pigments.

FIG. 18 is a graphical representation of C2 errors (measured using K-probe) for the same DVD as FIG. 17.

FIG. 19 is a schematic of a pattern marked on a clear disc.

FIG. 20 is a graphic illustration of reflectivity as a function of angular position on the clear disc of FIG. 19, marked with a 1,064 nm YAG laser.

FIG. 21 is a top view of the disc marked in accordance with the pattern of FIG. 19 and having the reflectivity illustrated in FIG. 21.

FIG. 22 is a graphical representation of reflectivity as a function of radial position on a clear disc marked with a 1,064 nm YAG laser.

FIG. 23 is a graphical representation of spectral data for Formulations B and C of Example 6, measured at thickness of 0.6 mm.

FIG. 24 is a top view of the disc formed from Formula B, marked in accordance with the pattern of FIG. 25, and having the reflectivity illustrated in FIG. 26.

FIG. 25 is a schematic of a pattern marked on a colored disc of Formula B.

FIG. 26 is a graphic illustration of reflectivity as a function of angular position on the colored disc of FIG. 25 marked with a 1,064 nm YAG laser.

FIG. 27 is a schematic of a CD-ROM, Recordable CD-R, or CDRROM.

FIG. 28 is a schematic of one embodiment of a CD-ROM with a unique ID within the substrate, created by post-molding marking of the disc.

FIG. 29 is a schematic of one embodiment of a CD-ROM with a unique ID showing the relationship between the marked spot and the “inspection area”.

FIG. 30 is one embodiment of a flow diagram for a manufacturing process to produce optical discs with the unique ID.

FIG. 31 is one embodiment of a flow diagram for a unique ID detection and decoding process.

### DETAILED DESCRIPTION

It is noted that the terms “first,” “second,” and the like, herein do not denote any amount, order, or importance, but rather are used to distinguish one element from another, and the terms “a” and “an” herein do not denote a limitation of quantity, but rather denote the presence of at least one of the referenced item. Additionally, all ranges disclosed herein are inclusive and combinable (e.g., the ranges of “up to 25 wt %, with 5 wt % to 20 wt % desired,” are inclusive of the endpoints and all intermediate values of the ranges of “5 wt % to 25 wt %,” etc.). The modifier “about” used in connection with a quantity is inclusive of the stated value and has the meaning dictated by the context (e.g., includes the degree of error associated with measurement of the particular quantity). The notation “±10%” means that the indicated measurement may be from an amount that is minus 10% to an amount that is plus 10% of the stated value. Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

Manufacturers, e.g., data storage disk manufacturers, desire to be able to distinguish one copy of a product from another copy of that product at least for tracking purposes, serial number assignments, and/or authentication. Tracking can include details like replicator location (i.e., the location of the entity making the copy), distribution and/or retailing locations, production dates and/or times, the production machines used to make the copy (e.g., so that the data can be correlated to other quality data like resin loading sequence, molding machine operating parameters, disc quality data, etc). Meanwhile, serial number assignments are desirable, for example, because they can be registered with the manufacturer in a central database thus entitling the authorized consumer to receive upgrades, technical support, access to bonus materials like games, merchandise, songs, promotional offers, and the like. Registration on a central database (e.g., “product activation”) can also serve as a key to unlock the contents on the disc and thus prevent counterfeiting of the discs or illegally copying the content since multiple registrations using the same serial number would signal a problem. The unique disc identifier could also be used to authenticate discs or to enable copy protection or digital rights management (DRM) software by matching the detected pattern to content or firmware instructions allowing the content to be displayed only when the correct match is obtained.

Serial numbers or unique identifiers (ID) can be used to prevent unauthorized software installation or access to the data locally stored on the disc or externally stored on the server. In one embodiment, unique ID or other data used to authenticate the disc can be retrieved during product installation or intermittently while the disc is in use. Unique ID can be used as a permanent ‘cookie’ to identify the user or computer accessing websites or external data. It is preferable that the structure of Unique ID is different from the standard data structure in a pre-recorded or recordable disc format to avoid easy duplication of the Unique ID by mastering or recording processes.

Disclosed herein are injection-moldable, light-markable (e.g., laser markable), optically clear thermoplastic compositions, optical media articles, systems, methods for creating different types of light-marks (e.g., spots) in bulk thermoplastic compositions (e.g., in the substrate), methods of encoding data, and methods of reading back encoded data to form a unique identifying sequence. Although the thermoplastic composition is discussed herein as polycarbonate for optical media applications for simplicity of discussion, it is understood that any optical quality (e.g., a haze of less than or equal to about 2%, transmission at a read wavelength of greater than or equal to about 80%, and low error counts) thermoplastic suitable for the particular application can be employed, e.g., optical media applications, secure identification cards, and the like. Low error counts are dependent upon the type of media. A CD is considered to have a low error rate if the average block error rate (BLER), over the whole disc, is less than 100, while a DVD is considered to have a low error rate if the 8-bit inner parity errors (PIsum8) are less than 280. More specifically, the optical quality thermoplastic, if for a CD, can have a BLER, over the whole disc, of less than or equal to about 50, and even more specifically, less than or equal to about 5.0, while for a DVD, the 8-bit inner parity errors (PIsum8) can be less than or equal to about 150, and even more specifically, less than or equal to about 50. Some possible thermoplastics include, for example, polycarbonate, polyacrylates, cyclic polyolefins, and the like, as well as combinations comprising at least one of the foregoing thermoplastics.

The polycarbonate composition can have sufficient absorption of energy (function of wavelength and power) at the marking wavelength so as to create a light-mark that will induce changes in optical properties of the media at the read wavelength (increase or decrease of absorption or change in scattering properties). Typically, the marking wavelength is different from the read wavelength, but in certain cases, the marking wavelength can be the same as the read wavelength. For example, a difference between the mark wavelength and the read wavelength can be greater than or equal to about ±30 nm, or, more specifically, a difference of greater than or equal to about ±100 nm. In other words, if the read wavelength is 650, the mark wavelength can be greater than or equal to about 680 nm or less than or equal to about 630 nm. The polycarbonate composition (i.e., the polycarbonate with the light-marking additives) can be optically clear with a haze of less than or equal to about 2%, specifically less than or equal to about 1.5%, and more specifically less than or equal to about 1%, as measured using a HazeGard or HazeGard Plus from BYK Gardner on a 2.5 millimeter (mm) thick color plaque. Optically clear injection molded substrates have an electrical error count within specifications for the particular disc format when molded using appropriate conditions for the format. Errors counts include PISum8, BLER, PO, PI errors, and the like. These polycarbonate compositions maintain the clarity and mechanical properties used for optical media substrates.

The polycarbonate compositions can have a sufficient stability, e.g., (i) a stability of transmission properties at the readback wavelength retained at greater than or equal to about 60%, specifically greater than or equal to about 75%, or more specifically greater than or equal to about 85% transmission after substrate molding at the appropriate substrate thickness defined by the media format; (ii) stability of polymer molecular weight or polymer melt viscosity to allow consistent molding of discs with minimum variation in thickness of substrates and quality of replication without adjusting process conditions; and/or (iii) parallel plate rheology, e.g., having a melt viscosity shift at 300° C., after a dwell time of 30 minutes, of less than or equal to about 15%, more specifically, less than or equal to about 10%, and more specifically less than or equal to about 5% are suitable for optical media replication.

The polycarbonate can be any optically clear polycarbonate, or, more specifically, injection moldable, optically clear polycarbonate. The polycarbonate compositions can have various molecular weights, depending upon the application. For example, the polycarbonate can have a weight average molecular weight (Mw) of about 16,000 atomic mass units (amu) to about 20,000 amu, or, more specifically, about 17,500 amu to about 18,500 amu.

The light-marking additive of the polycarbonate composition can comprise any material that can disperse in the polycarbonate, such as a material with a size of less than or equal to about 50 nanometers (nm), or, more specifically, less than or equal to about 25 nm, or even more specifically, and less than or equal to about 10 nm, as measured using transmission electron microscopy (TEM). The light-marking additive can be a material that does not affect transparency at a read wavelength and subsequently alters reflection (and/or transmission, as applicable) of the energy (e.g., absorbs the energy (e.g., light), refracts light, scatters the energy, and/or the like) at the read wavelength after it has been contacted with a marking wavelength (e.g., from a light, laser, and/or the like). The alteration can be an increase or decrease in reflection in the light-marked areas, essentially coming from marking of the thermoplastic substrate and not from damage to the metallization (e.g., reflective layer). For example, the material can change optical properties (e.g., change state upon stimulus by the marking wavelength and/or upon stimulus by a secondary component in the composition which is excited by the marking wavelength). Light absorption, for example, at the marking wavelength can be greater than or equal to about 0.5 absorbance units, or, more specifically, greater than or equal to about 1.0, or even more specifically, greater than or equal to about 2.0. Absorbance can be measured on color plaques using a spectrophotometer. This absorption enables a permanent change of state resulting in an alteration of reflectivity at the read wavelength in the light-marked areas (i.e., the change of state is not readily reversible such as between an absorbative and non-absorbative state). Even with fading and exposure to aggressive exposure conditions (e.g., prolonged sunlight exposure), the light-marks remain permanent, i.e., provide sufficient alteration at the read wavelength and do not revert to their original state. Reflectivity and transmission are altered by a light-mark that absorbs, refracts, and/or scatters light differently than the bulk optical material (i.e., the non-marked area of the substrate). For example, a light-mark can create a drive-readable error if its reflectivity is either sufficiently lower or sufficiently higher than the bulk optical material.

Exemplary light-marking additives can be found in the groups including: organic dyes and pigments such as: azo dyes, methine dyes, coumarins, pyrazolones, quinophtalones, quinacridones, perinones, anthraquinones, anthrapyridones, Vat dyes, phtalocyanines, and rylene derivatives (e.g., perylenes and quaterrylenes). For example, anthraquinones, or, more specifically, alkylamino substituted anthraquinones. Non-limiting examples of anthraquinone derivatives include compounds (A), (B), (C), and (D), while (E), (F), and (G), illustrate rylene derivatives (perylenes (n=0), terrylenes (n=1 or more), and quaterrylenes (n=2)): 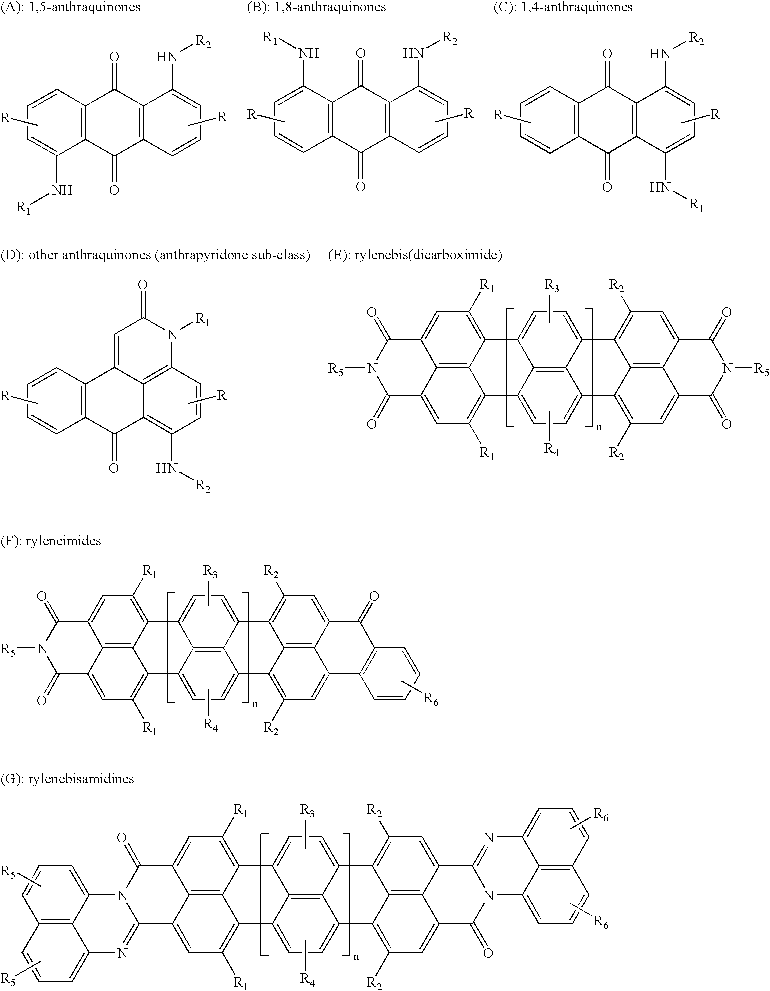
where R₁-R₄ are, individually, an alkyl group, an alkyl ether group, a cycloalkyl group, a cyclic ether group, an aryl group, an aryl ether group, an heterocyclic group, a carbonyl group, an ester group, or a carbonate group. R₅ and R₆, individually, represent a hydrogen, an alkyl group, an alkyl ether group, a cycloalkyl group, a cyclic ether group, an aryl group, an aryl ether group, an heterocyclic group, a carbonyl group, an ester group, a carbonate group, and/or the like. R represents single or multiple substituents including, but not limited to, hydrogen, hydroxy, and linear or cyclic groups including: alkyl, alcohol, alkoxy, aryl, sulfonyl, ketone, urethane, ester, ether, and thioether functionalities. Examples of rylene derivatives and their synthesis are reported in the article from K. Müllen and co-workers in the Journal of Materials Chemistry (1998), volume 8(11), pp 2357-2369.

Tetra-substituted anthraquinones may also be used for marking because of their absorption in or at the edge of the near-infrared region (NIR). Examples of NIR absorbing tetra-substituted anthraquinones include the dyes commercialized by Epolin based in Newark, N.J. such as Epolin 9151 and 9194. Aryl polymethine dyes may also be used for marking. Examples of aryl polymethine dyes include those described by Tuernmler, W. B., and Wilde, B. S., in the Journal of the American Chemical Society (1958), Volume 80, pp 3772-3777. The light-marking additive can be a precursor to an arylcarbonium dye (e.g., arylmethane, arylcarbinol, phthalein, sulfonephthalein, fluorans, and the like, as well as combinations comprising at least one of the foregoing). The arylcarbonium dye precursors are typically added in combination with a compound that locally changes the acidity of its surroundings after exposure to light and/or heat (e.g., a photoacid generator, also known as a latent acid). Structures of these are illustrated below. Examples of phthalein derivatives include Crystal Violet Lactone, phenolphthalein, and the like. Examples of arylmethanes include leuco Crystal Violet, leuco Malachite Green, and the like. 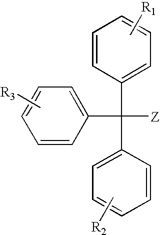
For an aryl methane dye, Z can be H; an aryl carbinol dye, Z can be OH; and for a substituted aryl methane dye, Z can be O-acyl, O-aryl, O-alkyl, O-silyl, S-alkyl, S-aryl, Si-alkyl, Si-aryl, or Si-alkoxy. 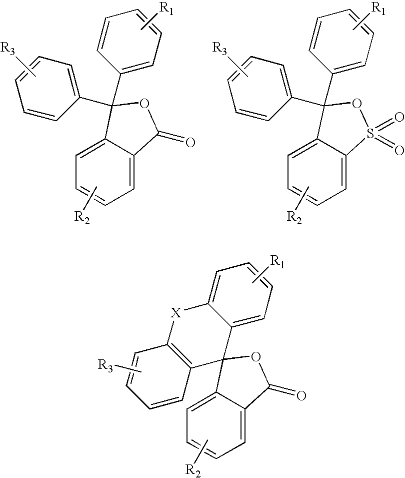
The aryl carbonium dye precursors (from left to right) are phthalein derivatives, sulfonephthalein derivatives, and fluorans, where X can be O or S.

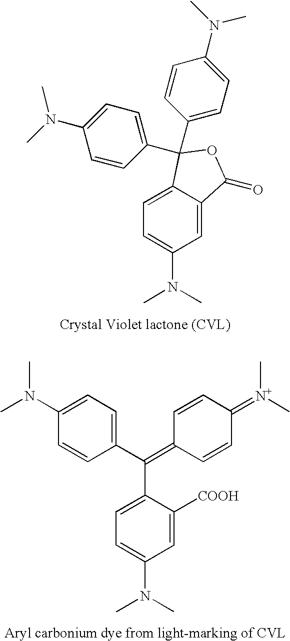

The light-marking additive could be molecules bearing urethane and/or carbonate groups. Dyes in the anthraquinone, perylene, terrylene, and quaterrylene families have amine functionalities present on the substrate, wherein the amino functionality can be modified to form a urethane bond (e.g., by reacting a chloroformate R₂OCOCl with the dye (—NH—R₁) in alkaline conditions), to form thermally labile groups that affect the conjugation of the molecule (transformation of —NH—R₁ into —NR₁—CO—O—R₂). Typically, the thermally labile group will act as an electron-withdrawing group and thus shift the maximum absorption peak of the dye to lower wavelengths. Upon heat exposure (e.g., indirectly induced by absorption of the laser light by the dye itself or by a co-absorber), the thermally labile group would come off the molecule whose absorbance would be shifted towards higher wavelengths. The R₂ substituent can be engineered to survive extrusion and molding but come off during the light-marking step. Generally, tertiary alkyl substituent exhibit the lowest heat stability (e.g., case of a t-Butyl group) compared to primary alkyl such as n-butyl group. If R₂ is a benzylic derivative (and especially a nitro substituted benzyl group), the dye can be photolabile in the UV region and the laser could then be used directly to remove the labile group and thus shift the maximum absorption of the dye. Similarly, thermally labile carbonate functionalities can be added to the light-marking additive in order to modify the electron conjugation of the system and impart sensitivity for light-marking. Such functionalization could involve a first step like a chemical reduction to further increase the marking sensitivity (absorption change during marking).

Exemplary light-marking additives include oxazines, diarylethene, spiro-naphthoxazines, naphthopyrans, fulgides, spiropyrans, anthraquinones, di- and tri-arylmethines, thiazines, anthroquinones, aza- and azo-dyes, quinones, indigo, and so forth. Some of these additives include: crystal violet lactone (e.g., CAS 1552-42-7), methyl green (e.g., methyl green zinc chloride salt (CAS 7114-03-6)), Organica Feincheme Wolfen “Dye 1093”, tetrazolium blue chloride (e.g., CAS 1871-22-3), photochromic dyes (e.g., Reversacol™ Palatinate Purple commercially available from James Robinson Ltd.; Plum1 commercially available from Color Change Corporation; Photopia Blue commercially available from Matsui International Company Inc., and so forth), protected forms of leuco methylene blue (e.g., benzoyl leuco methylene blue), reduced forms of methylene blue, brilliant cresyl blue, basic blue 3, toluidine blue, (4-{cyano[4-(dibutylamino)phenyl]methylene}cyclohexa-2,5-dien-1-yl)malononitrile, IR786 iodide (e.g., CAS 56289-67-9), IR775 chloride (2-[2-[2-Chloro-3-[2-(1,3-dihydro-1,3,3-trimethyl-2H-indol-2-ylidene)-ethylidene]-1-cyclohexen-1-yl]-ethenyl]-1,3,3-trimethyl-3H-indolium chloride), IR780 iodide (e.g., CAS 207399-07-3), copper phthalocyanines (e.g, Ultragreen MX™ commercially available from Ciba Specialty Chemical), and so forth. Combination comprising at least one of any of the above light-marking additives that are capable of forming the desired light-mark, can also be employed.

The light-marking additive particle size, after compounding in the polycarbonate (and/or other materials), should be sufficiently small to maintain the optical clarity of the substrate. If the additives are inorganic, for example, the particle size, measured along a major axis by Transmission Electron Microscopy (TEM), can be less than or equal to about 50 nanometers (nm), or, more specifically, less than or equal to 25 nm, and even more specifically, less than or equal to 10 nm, to be optically clear. Small initial particle size of inorganic nanoparticles outside the polycarbonate matrix may not necessarily guarantee the same particle size when dispersed in the matrix due to the tendency of the nanoparticles to aggregate. In such cases special precautions, e.g., coating and/or surface functionalization may be employed.

In addition to the polycarbonate and the light-marking additive, the substrate can comprise a photoacid generator (also known as latent acid) that locally changes the acidity of its surroundings after irradiation or application of heat. The photoacid generator(s) can be non-ionic, particularly when used in polycarbonate applications. Suitable photoacid generators include, for instance, a sulfonate derivative R₃SO₂OR₄, and the like, as well as combinations comprising the sulfonate derivative R₃SO₂OR₄. R₃ can be substituent designed such that R₃SO₃H is a strong Bronsted acid (R₃ typically contains an electron withdrawing group such as an alkyl, an aryl, a perfluoroalkyl group, or the like). R₄ can be a group designed to absorb light and create the sensitivity of the photoacid generator. Therefore, R₄ can be an aromatic group, such as an aryl group, or the like. The photoacid generator can be multifunctional. In one example, R₄ can be a trisubstituted phenyl moiety with 3 sulfonate groups located in positions 1, 3, and 5 of the phenyl ring. Examples of photoacid generators include N-Hydroxyphthalimide triflate, N-Hydroxynaphthalimide triflate, N-Hydroxy-5-norbornene-2,3-dicarboximide perfluoro-1-butanesulfonate (e.g., commercially available from Sigma-Aldrich); 1,1′-Bi-2-naphthol bis(trifluoromethanesulfonate) (e.g., commercially available from Strem Chemicals, Mass.), 1,2,3-trihydroxybenzene tris-phenylsulfonylester, and so forth. The latent acid can be covalently bonded to a polymer or otherwise immobilized, such as encapsulated in a shell and released from the shell upon exposure to heat, pressure, and/or light.

The amounts of the various components of the polycarbonate composition are dependent upon sufficient light-marking additive to enable marking of the substrate with minimal damage to the metallic layer (e.g., such that no damage to the metal layer is visible to the human eye from the non-read or label side of the disc (i.e., the side opposite the mark), and no damage is visible to the metallization using optical microscopy from the same side as the mark), and optionally, sufficient photoacid generator to react with the light-marking additive. The amount of light-marking additive depends on the extinction coefficient of the additive at the marking wavelength and also on the extinction coefficient of the marked species at the read wavelength. There can be a sufficient amount of light-marking additive such that, when marked, the mark will be detectable by the drive laser (e.g., there will be a sufficient change in reflectivity). For some light-marking additives, the amount present can be greater than or equal to about 0.001 wt %, based upon the total weight of the substrate. The amount of light-marking additive can be less than or equal to about 5 wt %, or, more specifically less than or equal to about 3 wt %, or, even more specifically less than or equal to about 1 wt %, and even more specifically, less than or equal to about 0.5 wt %. Typically an equimolar ratio of light-marking additive to photoacid generator can be used, e.g., 0.9 to 1.1 mole percent (mole %) of photoacid function for every mole of the light-marking additive.

In addition to the polycarbonate, the light-marking additive, and the photoacid generator, the substrate can comprise additional additive(s) such as filler(s) or reinforcing agent(s), heat stabilizer(s), colorant(s), antioxidant(s), light stabilizer(s), plasticizer(s), antistatic agent(s), mold releasing agent(s), additional resin(s), blowing agent(s), flame retardants(s), or the like, as well as combinations comprising at least one of the foregoing additional additives, that can be employed in an optical medium.

As discussed above, the substrate can be for use as an optical media (e.g., compact disc (CD) (e.g., recordable compact disc (CD-R), rewritable compact disc (CD-RW), and the like), magneto-optical disc, digital versatile disc (e.g., DVD-5, DVD-9, DVD-10, DVD-18, DVD-R, DVD-RW, DVD+RW, DVD-RAM, HD-DVD, and the like), Blu-Ray disc (BD), enhanced video disc (EVD), and recordable and re-writable Blu-Ray disc, and the like), wherein the substrate has a thickness of greater than or equal to about 0.3 millimeters (mm), or more specifically, greater than or equal to about 0.6 mm, and optionally, greater than or equal to about 1.0 mm.

In order to enable readability of the data layer (which can comprise a separate layer and/or comprise pits and lands in the substrate surface), the electrical reflectivity of the non-marked regions can be greater than or equal to 30%, and more specifically, greater than or equal to 45%, and, in some applications, greater than or equal to 65%. Reflectivity typically refers to electrical reflectivity, measured using a tester, such as CD-CATS from CD Associates, DVD-Pro from AudioDev, and the like. If the mark is large enough (greater than 1 millimeter (mm)), then reflectivity can be measured using optical methods, (e.g., optical tester like Prometeus MT-146, MT-136, and the like, manufactured by Dr. Schenk).

The light-mark(s), one or more of which may optionally be encrypted, can be formed in one or more substrate(s) forming the optical media, and can be detected in an optical disc drive, for example, due to a reflectivity difference between the light-mark and the unmarked area of the substrate. The reflectivity difference, for example, can be greater than or equal to 15%, or, more specifically, greater than or equal to 30%, and even more specifically, greater than or equal to 45%.

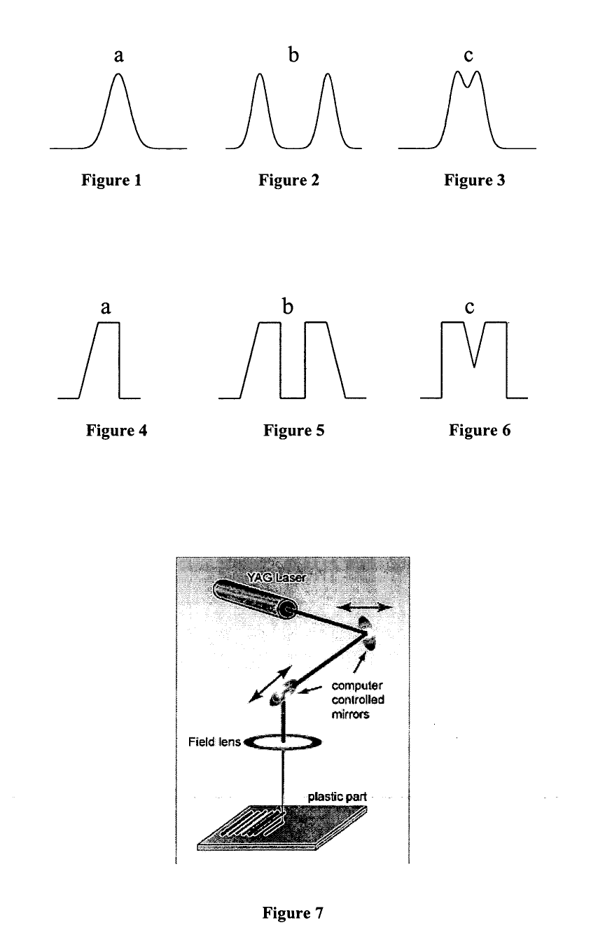

The pattern of the light-mark(s), (e.g., length and/or width of a light-mark, and/or the length, width, and/or spacing between light-marks) can be tailored to create unique reflectivity patterns (e.g., sinusoidal waves, step changes, and the like, as well as combinations comprising at least one of these patterns). For example, the laser spatial profile inside the disc substrate can be a signature of the light-mark. Depending on the laser beam entering the focusing lens, the focused light-mark in the disc substrate can be, for example, Gaussian, Airy (sinc function), flat top, and the like, as well as combinations comprising at least one of the foregoing. (See FIGS. 1-6) The light-mark can have an indistinct geometry or can form a special pattern (e.g., a logo, trademark, word, shape, and the like, as well as combinations comprising at least one of the foregoing). In addition, the light-mark can follow a specific path like a CD-R groove, or it can form its own path with a special periodicity. In the latter case, the laser (or light) power can be modulated to create a wobble path with alternating regions of high and low reflectivity and the periodicity could enable some form of tracking.

The light-mark size, that can be microscopic or macroscopic, is dependent upon the device employed to form the light-mark. For example, the light-mark can be as small as 1 micrometer in diameter (measured along the major axis (i.e., the longest axis), so that it can only be seen with magnification (e.g., with a microscope)). For example, the light-mark diameter can be 0.1 micrometer to 100 micrometers. On the substrate surface, the light-mark size can be as large as 0.5 millimeters (mm), or so. In order to light-mark content in a localized address (e.g., one or more adjacent logical block addresses), the light-mark can be small (e.g., less than or equal to about 100 micrometers) and at a depth close to the reflective layer. For example, the light-mark can be disposed in a region of the disc and/or in a mastered data groove. A series of light-marks can also form a pattern, e.g., wherein each individual light-mark has a special feature. For example, the pattern can be a company logo formed by multiple light-marks (e.g., is a logo, or the like).

Light-mark(s) can be divided, for example into two basic categories; small and large. Each small light-mark can have a size sufficient to modify a readable bit stream such that it can be within a data section, e.g., small light-mark(s) can have dimensions similar to the size of pits, grooves, and/or lands (i.e., the data on the disk). For example, for a CD, the size for a pit is about 0.83 micrometers (3 T) to about 3.05 micrometers (11 T), while for a DVD, the pit size can be up to about 0.4 micrometers. These light-mark(s) can be detected as data if they follow the data format (and/or they can be a change in the data (such as from a 1 to a 0), and/or they can be invalid, resulting in errors during playback. In other words, the light marks can be detected as errors or as a change in the data. These error-producing light-mark(s) can be in the form of non-standard pit and land dimensions and/or sequences of pits and lands that are invalid. The location of the “errors” and/or “hidden bits” is another method for embedding a unique identifier into optical media. For instance, the unique signature can be hidden within the data section of the disc, as compared to barcodes or other features light-marked into the burst cutting area (BCA) region of the disc. For example, a modifiable bit at logical block address (LBA) 1,000 can have two pieces of information that make it unique 1) either the bit is a one or zero, and 2) the location has an odd checksum or error state. Thus with only one bit, the piece of optical media is light-marked with 4 possible states [0,0] [1,0] [0,1] [1,1] (where [bit, presence or absence of error]).

Each large light-mark is too large to “hide” within a data section, e.g., a large light-mark can cover more than one pit and land, and/or span a number of logical block addresses. A large light-mark can be used to create errors that are detectable by optical disc drives. Some light-mark types on a CD are set forth in Table 1.

TABLE 1

| | Reflec- | Disc (Non- | | | |
|---|---|---|---|---|---|
| | tivity | marked | Diameter of | | |
| Mark Type | of Mark | Reflectivity | Mark | | Error Type |
| “Dark” Mark | <45% | >60% | 0.1-0.5 | μm | Valid data - |
| | | | | | no error |
| “Dark” Mark | <45% | >60% | <1 | mm | C1 |
| | | | | | correctable |
| “Dark” Mark | <45% | >60% | 1-3 | mm | C1 & C2 |
| | | | | | correctable |
| “Dark” Mark | <45% | >60% | >3 | mm | Un- |
| | | | | | correctable |
| “Light” Mark | <45% | >60% | 0.1-0.5 | μm | Valid data - |
| | | | | | no error |
| “Light” Mark | >60% | 30 to 45% | <1 | mm | C1 |
| | | | | | correctable |
| “Light” Mark | >60% | 30 to 45% | 1-3 | mm | C1 & C2 |
| | | | | | correctable |
| “Light” Mark | >60% | 30 to 45% | >3 | mm | Un- |
| | | | | | correctable |

CDs and DVDs utilize an error-correction scheme to correct for imperfections, in or on the disc, such as replication imperfections, dust, fingerprints, and poor mastering of the data. The error detection and correction code used on CDs is called the Cross Interleave Reed-Solomon Code (CIRC). CDs use data redundancy and interleaving to detect and correct errors. The CIRC error correction used in CD drives and players is composed of two stages called C1 and C2 with de-interleaving of data between the stages. Generally, a drive can detect and correct two bad symbols per block in the first stage and three or four bad symbols per block in the second stage (depending on the drive). Hence, errors can be described as C1 correctable if they are corrected in the first stage and C2 correctable if they are corrected in the second stage. An E11 error means one bad symbol was corrected in the first stage, E21 means two bad symbols were corrected in the first stage. E31 means three bad symbols were present in the first stage; this block is uncorrectable at the C1 stage and so is passed to the second stage. E12 means one bad symbol was corrected in the second stage and E22 means two bad symbols were corrected in the second stage. E32 means there were 3 or more bad symbols in the second stage. Some drives can correct up to 4 bad symbols at the second stage. If the error cannot be corrected in the second stage, it generally results in an uncorrectable error.

DVD players use a different error correction protocol based on a Reed Solomon product code. A block of data is examined using parity rows and columns. In this case, if there are six bad bytes in a row, the row is flagged as a PI (inner parity) failure or error. The raw data may still be recovered using outer parity bytes. If there are more than seven bad bytes in a column, the column is flagged as a PO (outer parity) failure or error. Blocks that are flagged as PO failures are unusable and data is lost.

The impact of the light-marks on error type (C1, C2, or uncorrectable error in the case of CD; and PI or PO failure errors in the case of DVD) will be a function of the disc format, the number of light-marks, and the density and physical placement of the light-marks. Hence, the light-mark(s) (e.g., the optically induced signature) can be a C1 error, C2 error, PI error, PO error, an uncorrectable error, a bad sector, or the like, as well as combinations comprising at least one of the foregoing. The optically induced signature can also be at least one data bit that has a changed data state relative to a predetermined data state due to presence of the light-mark(s).

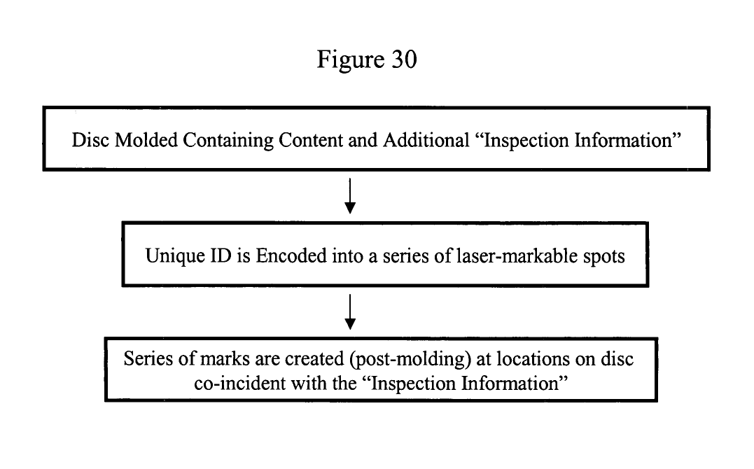

One way to create a unique serial number for optical storage discs is to control the placement, size, and/or design of light-marks on the discs so that each disc has a unique pattern of light-marks that translates into an identifier (e.g., a serial number). As is shown in FIG. 30, the Unique ID can be formed by molding a disc comprising the desired data and the inspection data (e.g., the information regarding the unique ID, such as location, etc.). The molded disc comprises the data layer, reflective layer(s), and optionally other layers. The Unique ID can then be formed into the molded disc by contacting the disc with a light (e.g. a laser light). The light contacts the light-marking additive in the substrate, forming mark(s) or a series of marks, post-molding, at locations co-incident with the inspection data.

The light-marks can be formed with an energy source such as a laser (e.g., gas (such as YAG, HeNe, HeCd, CO₂, N₂, Ar, Excimer, and the like), pumped solid state, dye and semiconductor diode lasers), and/or other light sources (e.g., UV lamps used in conjunction with photomasks, spatial light modulators, and the like), as well as combinations comprising at least one of the foregoing energy sources. Low power laser diodes offer a lower capital investment, lower maintenance and downtime, as well as other advantages. Depending upon the sensitivity of the light-marking additive employed and the desired marking time, the laser can have a power of less than or equal to about 200 milliwatts (mW), or more specifically, less than or equal to about 150 mW, and even more specifically, less than or equal to about 100 mW (e.g., about 30 mW to about 100 mW). Non-limiting examples of lasers are presented in Table 2.

TABLE 2

| Source | Spectral range of emission (nm) |
|---|---|
| Continuous wave | |
| Diode lasers | different diode lasers cover about 400 to 1,500 nm |
| Argon ion laser | several lines over 350-514 nm |
| Helium-neon laser | several lines over 543-633 nm |
| Krypton laser | several lines over 530-676 nm |
| Pulsed | |
| Nitrogen laser | 337 nm |
| Nd: YAG laser | fundamental - 1064, frequency doubled - 532, |
| | tripled - 355 |
| Ti: Sapphire laser | 720-1000, frequency doubled 360-500 |
| Dye lasers | 400-900 |
| F2 | 157 |

Possible laser diodes for reading and tracking in optical drives and testers include, for example, blue lasers (405±30 nm), red lasers (650±30 nm), and near-IR laser (780±30 nm). In one embodiment, the light-mark can be created such that it is in the substrate and does not physically damage other portions (e.g., the metallization or the surface) of the disc, yet provides sufficient reflectivity difference (e.g., higher or lower reflectivity) from the surrounding unmarked medium to create a distinct (i.e., a measurable) pattern, i.e., an identifier. The difference in reflectivity between a light-mark and an unmarked area of the article (or composition) is sufficient such that the read device can distinguish light-marks from unmarked areas. A large light-mark can be formed by marking multiple small light-marks such that detectable uncorrectable errors are created. If the small light-marks were singly disposed or disposed with a low density, they would be interpreted as correctable in the optical drive, but because the multiple light-marks are marked in close proximity to one another, they cause an uncorrectable error.

In order to light-mark the substrate (e.g., to place a mark in the substrate), the substrate is contacted with sufficient energy (e.g., laser energy) to cause the light-marking additive to form a mark in the substrate (e.g., absorbs energy and creates a spot). Desirably, the energy is insufficient to damage (e.g., to burn, or the like) the substrate (e.g., polycarbonate), or metal layer. For example, a laser can be pulsed (running at 10 to 100 kilohertz (kHz)), continuous wave (CW), or quasi-CW. Quasi-CW is pulse laser running at very fast pulse repetition rate (typically greater than or equal to 100 megahertz (MHz)), so it is operated like a CW laser to typical motion system. The laser wavelength can be ultraviolet (UV) (e.g., UV laser, diode pumped solid-state laser, or the like), visible (e.g., solid state laser, diode, or the like), or infrared (e.g., diode, solid state laser, carbon dioxide (CO₂) laser, or the like), or the like. Desirably, the laser wavelength sufficiently matches an absorption wavelength of the light-marking additive to cause a chemical and/or physical property change in the additive.

Various laser focus schemes can be used to focus the laser mark at various depths inside the substrate, wherein the disc drive reading laser focuses on the reflective or metallized layer. For example, the marking laser can be focused so that the light-marked dye pattern is like a funnel inside the substrate. If the light-mark size is large (e.g., about 100 micrometers), a collimated laser beam can be used so that the light-marked additive has the same light-mark size throughout the disc. Alternatively, a non-linear absorbing dye (e.g., absorbance characteristic of the dye is not a linear function of the laser power) could be used together with a laser focused at the content layer to write a sub-micrometer feature inside the substrate.

An exemplary light marking system, as illustrated in FIG. 7, uses a galvo mirror to dispose the light-mark on the disc. The advantage of this system is its speed. Since the leg can be very long, any angular movement of the mirror causes big movement on the disc. But this system, however cannot write less than 10 micrometer features on the disc.

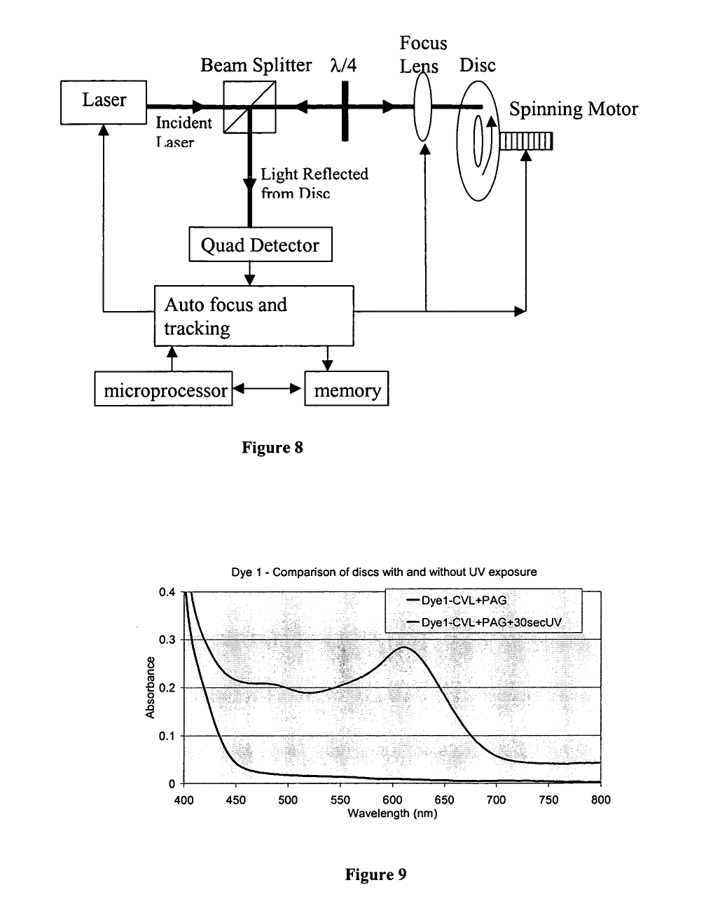

Another exemplary light marking system is illustrated in FIG. 8. This system moves and rotates the optical disc. With this system, for large features, the x-y linear stage is moved. For example, Aerotech Inc. or Newport Corp. air bearing linear stage with optical encoder can attain a 0.1 micrometer accuracy. For small features, an autofocusing and tracking system can be employed. The optical disc content can be mapped in the x-y dimension using linear stage to do the writing.

The identifier can then be recognized during disc read-back (e.g., in standard, legacy drives), and deciphered to provide a code (e.g., translated into a number string, unique serial number, or the like), e.g., that can be compared to a set of codes to determine the authenticity of the disc. In addition, the structure of the identifier can be traced to a specific algorithm generating authentic codes, similar to some serial number generators. For example, in one embodiment, the light-mark(s) can be detected as errors by an optical disc drive and the locations of the errors can be coded into a serial number. Errors related to reading data from an optical data storage disc typically originate from three sources, focusing errors, tracking/synchronization errors, and reading errors. The light-mark(s) can be used to cause the drive to detect errors at the locations of the light-mark(s). In another embodiment, the pattern created by the succession of marks can correspond to data or a combination of data and errors (such as those marked in the polycarbonate on top of the groove, or the pattern can form a wobbling groove). If the identifier is in the form of readable data, then it can be structured so that it is in a non-standard format to avoid duplication by known techniques. It is conceivable that the special periodicity of the wobbling path can be used as an identifier to confirm the origin of the Unique ID.

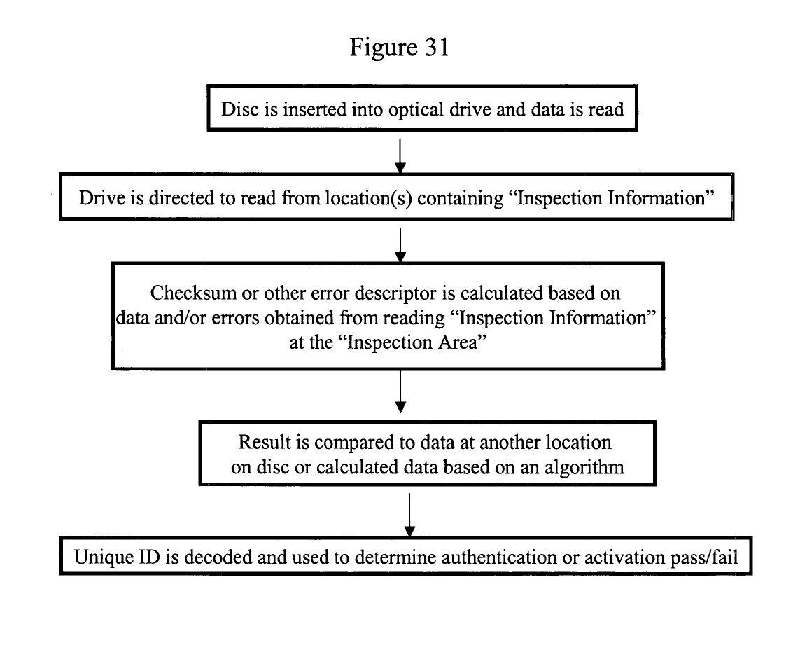

As is shown in FIG. 31, the disc can be inserted into an optical drive (e.g., a standard CD or DVD drive, as is appropriate). Based upon the inspection data on the disc, the drive can be instructed to read from the location on the disc comprising the Unique ID. An error descriptor can be calculated based upon data and/or errors obtained from reading from the designated location. The descriptor can then be compared to data elsewhere on the disc, data in the inspection data, calculated data (e.g., based upon an algorithm), and/or the like. The Unique ID can be decoded and used to determine the desired information; e.g., authentication, activation pass/fail, and/or the like. The resultant information can then be used in determining how to proceed (e.g., play the disc, reject the disc, send a counterfeit notification, etc.)

In addition to the substrate, the storage medium can optionally comprise data, data layer(s), lubricating layer(s), protective layer(s), adhesive layer(s), dielectric layer(s), reflective layer(s), insulating layer(s), and/or the like, as well as combinations comprising at least one of these layers. The data storage layer(s) may be a data storage material and/or can comprise pits, grooves, lands, and the like, as well as combinations comprising at least one of the foregoing, disposed into the substrate, or the like. Data storage material can be any material capable of storing retrievable data. The data storage layer may have a thickness of less than or equal to 600 Å, or, more specifically, less than or equal to 300 Å. Possible data storage materials include oxides (such as silicone oxide), rare earth element—transition metal alloy, nickel, cobalt, chromium, tantalum, platinum, terbium, gadolinium, iron, boron, as well as alloys and combinations comprising at least one of the foregoing, and others, such as organic dye (e.g., cyanine or phthalocyanine type dyes), and inorganic phase change compounds (e.g., TeSeSn or InAgSb), a liquid crystal material, dye that changes state, photochromic material, materials that change color due to change in crystalline state (e.g., Ge, Sb, and Te materials, and their alloys with Sb, Cd, and Tn), fluorescent materials, and the like, as well as combinations comprising at least one of the above data storage materials.

The dielectric layer(s), which are often employed as heat controllers, can typically have a thickness of up to or exceeding 1,000 Å and as low as 200 Å. Possible dielectric layers include nitrides (e.g., silicon nitride, aluminum nitride, and others); oxides (e.g., aluminum oxide); carbides (e.g., silicon carbide); and combinations comprising at least one of the foregoing dielectric layers, among other materials compatible within the environment.

The reflective layer(s) should have a sufficient thickness to reflect a sufficient amount of energy to enable data retrieval. The reflective layer(s) can have a thickness of up to and sometimes exceeding 700 Å, or, more specifically, 300 Å to 600 Å. Possible reflective layers include any material capable of reflecting the particular energy field, including metals (e.g., aluminum, silver, gold, titanium, and the like, as well as alloys and mixtures comprising at least one of the foregoing materials and others). The reflective layers may be disposed on the substrate by various techniques such as sputtering, chemical vapor deposition, electroplating and the like.

Optionally disposed between an optical layer and the data storage layer, and/or between other layers, is an adhesive layer that can, for example, adhere the optical layer to the other layers supported by the substrate. The adhesive layer can also be employed to enhance the dampening of the disc, with the thickness and nature of the adhesive determining the amount of dampening provided by the layer. The adhesive layer, which can have a thickness of less than or equal to about 70 micrometers, specifically, about 30 to about 70 micrometers (μm), or, more specifically, a thickness of about 45 micrometers to about 55 micrometers, can comprise rubber based or elastomeric thermosets, flexible thermoplastics, and the like. Typical adhesives are rubber-based or rubber-like materials, such as natural rubber or silicone rubber or acrylic ester polymers, and the like. Non-rigid polymeric adhesives such as those based on rubber or acrylic polymers and the like have some of the properties of elastomers, such as flexibility, creep resistance, resilience, and elasticity, and do provide useful dampening to enhance the quality of playback of the data storage disc. Acrylic based adhesives can be used for multi-layer discs, particularly when the laser reads through the adhesive layer.

In addition to the data storage layer(s), dielectric layer(s), protective layer(s) and reflective layer(s), other layers can optionally be employed, such as lubrication layer(s) and others. Useful lubricants include fluoro compounds, especially fluoro oils and greases, and the like.

### EXAMPLES

### Example 1

### A polycarbonate Film with a Laser Markable Dye

A 0.1 mm thick film of polycarbonate was produced by dissolving a melt polycarbonate sample in chloroform (about 10 wt %) and adding about 1-5 wt % of crystal violet lactone (wt % in total solution to form a polycarbonate composition. The film was solvent-casted onto a glass substrate. After solvent evaporation, the film was light-marked using a 355 nm laser positioned vertically, normal to the surface of the film, at a distance of 10 cm. The laser was a compact Nd:YAG laser (commercially available from Nanolase, France) operating at 5 kilohertz (kHz) with an average laser power of 15 milliwatts (mW). The film was positioned on an XY stage. The stage was activated to move at a rate of 1 millimeter per second (mm/s) in a predetermined pattern to form the light-mark. The resultant film had a marking that was about 1 to about 2 mm in diameter that was detectable with a portable fiber-optic spectroscopic system. The system included a white light source (halogen lamp, Ocean Optics, Inc., Dunedin, Fla.), and a portable spectrometer (Ocean Optics, Model ST2000). The spectrometer was equipped with a 200-μm slit, 600-grooves/mm grating blazed at 400 nm and covering the spectral range from 250 to 800 nm with efficiency greater than 30%, and a linear CCD-array detector. Light from the source was focused into one of the arms of a “six-around-one” bifurcated fiber-optic reflection probe (Ocean Optics, Inc., Model R400-7-UV/VIS). Light reflected from the film was collected from a sample when the common end of the fiber-optic probe was positioned near the sample at a 10-20 degree angle normal to the surface. The second arm of the probe was coupled to the spectrofluorometer.

### Example 2

### Injection-Molded Disc Comprising a Dye-Doped Polycarbonate

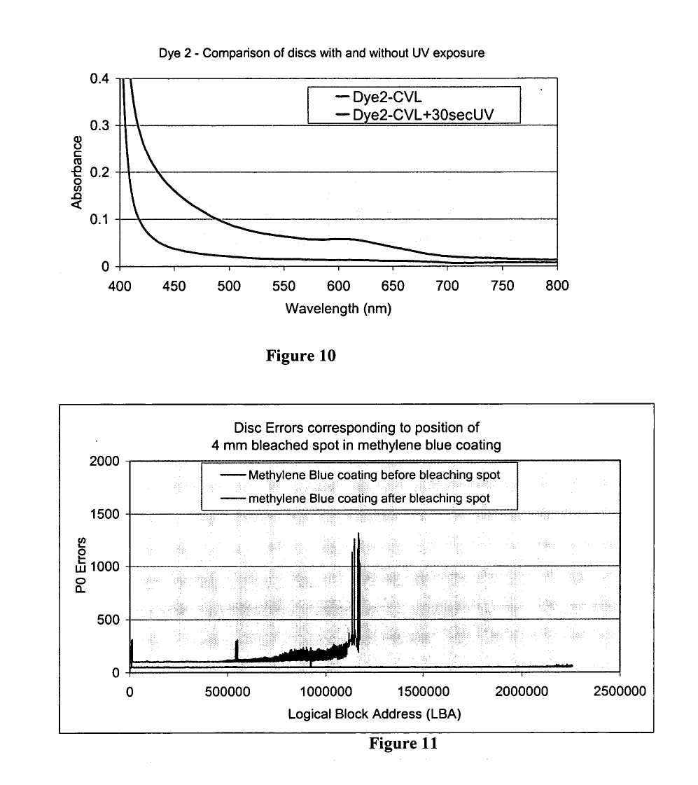

Polycarbonate powder (500 grams) was blended with 0.672 wt % crystal violet lactone (CVL) and 0.34 wt % photoacid generator (PAG) 1,2,3-trihydroxybenzene tris-phenylsulfonylester, based upon the total weight of polycarbonate, in a Henschel mixer. The blends were molded into discs 57 mm in diameter and 1.2 mm in thickness, in a Mini-jector injection molder using an injection temperature of 280° C. Comparative samples containing 3 wt % crystal violet lactone without the photoacid generator and samples containing neither crystal violet lactone nor the photoacid generator were also prepared. The samples were exposed to UV light either with a 355 nm UV laser or to a flash UV lamp (Xenon Corp.) for a period of 30 seconds. After exposure to UV light, the samples were measured using an Ocean Optics UV-Vis spectrophotometer. UV-vis spectra of the samples with PAG and without PAG are shown in FIGS. 9 and 10, respectively. Spectra of the samples before and after exposure to 30 sec of UV light exposure using the Xenon flash lamp are also shown in these Figures. Table 3 summarizes the absorbances of the samples at several wavelengths. The data indicates that the dye-doped polycarbonate discs were sensitive to exposure to UV light, as is indicated by the increased absorbances at 532 and 650 nm. Furthermore, the data indicate that the sample containing both crystal violet lactone and photoacid generator showed a greater increase in absorbance at 650 nm after UV light exposure.

TABLE 3

| Sample Disc | Absorption at 532 nm | | Absorption at 650 nm | |
|---|---|---|---|---|
| Composition | Before UV | After UV | Before UV | After UV |
| CVL only | 0.025 | 0.075 | 0 | 0.050 |
| CVL and PAG | 0.025 | 0.200 | 0 | 0.200 |

### Example 3

### Light-Marking of Injection-Molded Discs Comprising Dye-Doped Polycarbonate

Polycarbonate powder (500 grams) was blended with dyes of concentrations of 0.01 wt % to 0.3 wt %, based upon the total weight of polycarbonate, in a Henschel mixer. As in the example above, the blends were molded into discs 57 mm in diameter and 1.2 mm in thickness, in a Mini-jector injection molder using an injection temperature of 280° C. The discs were exposed to various light sources including a pulsed 355 nm Nd:YAG laser operating at 9 kilohertz (kHz) and pulse width of 400 picoseconds (ps) with an average laser power of 15 milliwatts (mW), a 532 nm Nd:YAG laser operating at 5 kilohertz (kHz) and pulse width of 400 picoseconds (ps) with an average laser power of 15 mW, a 650 nm laser diode with a continuous laser power of 60 mW, and a 780 nm laser diode with a continuous laser power of 80 mW. The samples were positioned perpendicular to the light sources at a distance of about 10 cm. The light-marking compound (e.g., dye) compositions included anthraquinones, di- and tri-arylmethines, oxazines, thiazines, anthroquinones, aza- and azo-dyes, quinones, indigo and other dyes. UV-visible absorbance spectra of the parts before and after light exposure were measured.

Table 4 summarizes the effect of the laser exposure for each dye used in the PC composition. Depending on the dye, the exposure yielded a light-mark (either a spot of higher absorbance (“darkened”) or of lower absorbance (“lightened”) after exposure to light), or did not form a mark under these particular conditions (“no effect”). For some of the samples (“degraded”), the dyes degraded during the high-temperature molding process. It is noted that although many of the photochromic dyes set forth in Table 4 are known to be reversibly switchable between absorptive and non-absorptive states when placed in an appropriate matrix such as a coating, when these dyes were placed in the disc substrates (e.g., polycarbonate substrate), they did not exhibit a reversible behavior but have shown a surprisingly stable (“permanent”) change of state.

It can be readily appreciated that an unexpected few number of polycarbonate/dye compositions can survive the injection molding process and form a detectable mark upon exposure to light from low power lasers. It can also be appreciated that some of the dyes listed below that were not light-markable using the conditions of the current experiment (including laser wavelength and power) may become light-markable if alternative experimental conditions were used (for example, if high laser power or marking time were used).

TABLE 4

| Light-marking additive (e.g., Dye) | Effect |
|---|---|
| Solvent Blue 35 | No Effect |
| Solvent Blue 59 | No Effect |
| Solvent Green 3 | No Effect |
| Nile Blue A | Degraded |
| Morin Hydrate | Degraded |
| Coomassie Brilliant Blue | Degraded |
| Indigo Blue | No Effect |
| Rhodamine 6G | No Effect |
| Fluorescein | Degraded |
| Chromotrope 2B | No Effect |
| 1,3-Bis(4-(Dimethylamino)-2-Hydroxyphenyl)- | No Effect |
| 2,4-Dihydroxycyclobutenediylium(OH)2 | |
| Lumogen F Violet 570 | No Effect |
| Rhodamine 800 | Degraded |
| Crystal Violet Lactone | Darkened |
| Trypan Blue (Direct Blue 14) | No Effect |
| Methyl Green | Lightened |
| Organica Feincheme Wolfen (“Dye 1093”) | Lightened |
| tetrazolium blue chloride | Darkened |
| James Robinson Plum 1 Photochromic | Darkened |
| James Robinson Palatinate Purple Photochromic | Darkened |
| Benzoyl leuco methylene blue | Darkened |
| (4-{cyano[4- | Lightened |
| (dibutylamino)phenyl]methylene}cyclohexa-2,5- | |
| dien-1-yl)malononitrile | |
| IR-786 iodide | Lightened |
| IR-775 iodide | Lightened |

### Example 4

### Injection-Molded CD Comprising a Light-Markable Dye-Doped Polycarbonate Substrate

A mixture of 12 kg of powdered polycarbonate resin (Lexan OQ1030L) was blended in a high shear mixer (Henchel Mixer, model RL086202) with 0.20 wt % crystal violet lactone and 0.30 wt % of a photoacid generator, 1,2,3-trihydroxybenzene tris-phenylsulfonylester. The blend was extruded at approximately 265° C. in a W&P twin-screw 28 mm extruder. The extruded resin system was chopped to form pellets that contained the light-markable dye/photoacid generator system. The pellets were molded into discs at approximately 335° C. in a Sumitomo SD30 injection molder with a Seikoh Giken J Type CD Mold, metallized with aluminum and coated with lacquer in a Steag Unijet to form playable CD-ROM discs.

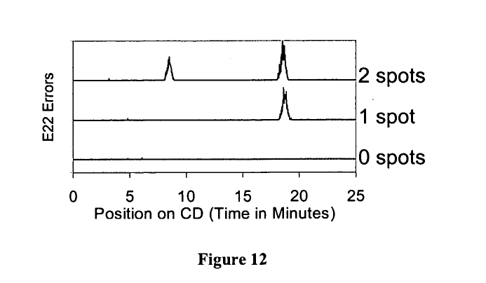

The CD-ROM discs were light-marked with a 355 nm laser (JDS Uniphase model NV-10210-100) to form elliptical spots with dimensions of approximately 357×541 micrometers to approximately 579×825 micrometers. One CD-ROM disc was light-marked with two spots with approximate dimensions of 548×747 micrometers, at approximate locations corresponding to 8 and 18 minutes on the CD-ROM. This disc was marked and tested sequentially after 0, 1, and 2 spots were light-marked on the disc. A Clover Systems High-Speed CD Analyzer was then used to detect the presence (or absence) of CIRC errors generated during playback of the light-marked discs. FIG. 12 indicates that one band (a band is defined as multiple errors occurring at a range of logical block addresses or sectors on the disc) of E22 errors were present on the disc containing one light-marked spot and two bands of E22 errors were present on the disc containing two light-marked spots.

### Example 5

### Coated DVD with “Dark” Spot

A polycarbonate DVD was spotted with an alcohol solution containing black pigments. Data errors were measured using K-probe (K-probe is a commercially available software tool that uses an optical disc drive to detect errors on optical discs) revealing a correlation between number of spots, placement of spots, and resulting magnitude and position (logical block address) of the errors. FIGS. 13 and 15 show the placement of the spots, while FIGS. 14 and 16 show the distribution and magnitude of PI errors as a function of logical block address. FIGS. 14 and 16 illustrate that the radial placement of the spots on the disc has a substantial impact on which logical block addresses contain errors.

### Example 6

### Coated CD with “Dark” Spot

A CD was spotted with an alcohol solution containing black pigments. The resulting spot on the surface of the disk was about 3 mm in diameter. Data errors (C1 and C2) were measured using K-probe, revealing an error signature specific to the size, shape and reflectivity of the mark and location of the mark on the disk. Figures 17 and 18 illustrate the uniqueness of C1 and C2 distributions on the disc. Multiple marks on the disc can create even more complex signatures that, combined with an encoding scheme, can be detectable in the drive and decoded to obtain data such as an unique identifier.

### Example 7

### Coated DVD with “Light” Spots

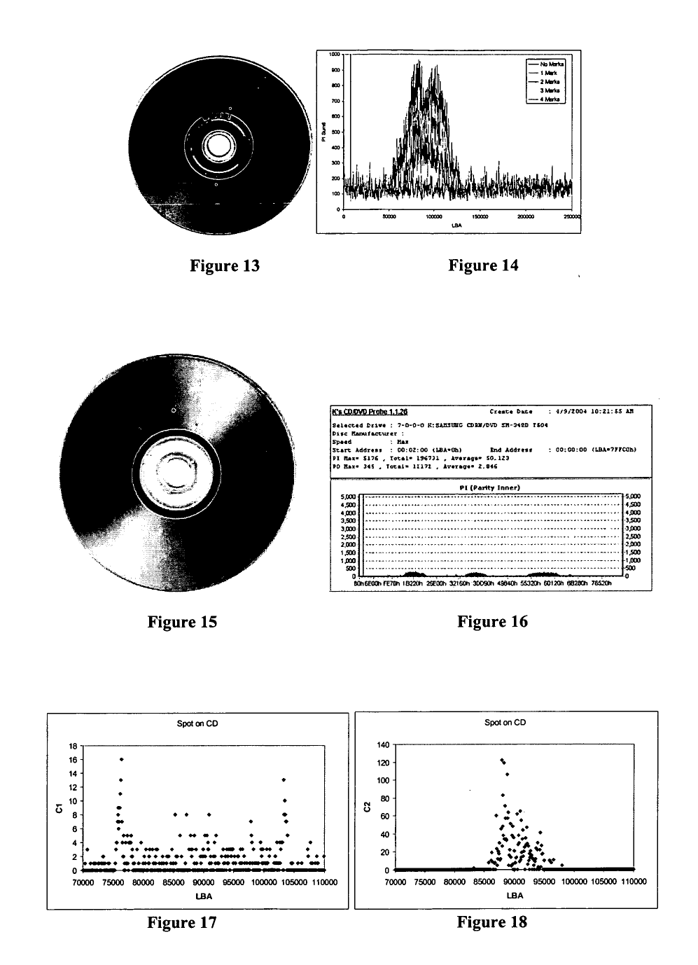

A solution of 0.15 wt % methylene blue dye and 15 wt % polymethylmethacrylate in Dowanol PM™ (a methoxy-propanol commercially available from Dow Chemical) was spin-coated onto the read-side of a DVD. When the solution dried a blue film was formed on the data side of the DVD, which decreased the DVDs average reflectivity from 65% to 49%, FIG. 9. The disc was masked to expose a 4 mm diameter spot on the methylene blue film. The unmasked hole was exposed to visible light from a white light source for 18 hours. The light bleached the methylene blue dye leaving a colorless spot of approximately 4 mm diameter. K-probe, a commercially available software tool, was used to detect errors on DVDs. The methylene blue coated disc was tested for errors with K-Probe before and after the 4 mm bleached spot was created. The results of the K-Probe analysis in FIG. 11 shows that there were relatively few errors on the blue disc before a single 4 mm spot was created. The spot caused a dramatic increase in the number of PO outer parity errors on the DVD at the logical block addresses that correspond to the radial location of the 4 mm spot.

### Example 8

### DVD with a Laser-Mark Pattern

Optical quality (O) polycarbonate pellets were produced as per the formulations outlined in Table 5. OQ polycarbonate resin powder was mixed with additives (heat stabilizer and mold release) and dyes using a mechanical tumbler until a homogenous mixture was obtained (typically 30 to 40 minutes for a 30 kilogram (kg) batch). The mixture was then extruded on a Werner and Pfleiderer ZSK-30 model twin-screw extruder. The extrusion conditions employed were as follows: Zone 1=480° F. (249° C.); Zone 2=500° F. (260° C.); Zone 3=520° F. (271° C.); Zone 4=540° F. (282° C.); Zone 5=550° F. (288° C.); Die head=550° F. (288° C.); and Screw speed=400 to 450 revolutions per minute (rpm). The polymer strands coming out of the die head were cooled using a water bath and pelletized. DVDs were molded from the pelletized material using Sumitomo SD30 molding machines equipped with Seiko Geikin DVD molds. Metallization and bonding was completed on a Steag Hamatech Unline 3000 DVD Bonder and Unaxis metallizers.

TABLE 5

| | Sample (parts by weight) | | |
|---|---|---|---|
| | Formulation | | |
| | A | Formulation B | Formulation C |
| Polycarbonate resin | 100 | 100 | 100 |
| (17,700 amu) | | | |
| Mold release agent | 0.03 | 0.03 | 0.03 |
| Heat stabilizer | 0.02 | 0.02 | 0.02 |
| 1,5-bis(cyclohexylamino) | — | 0.4 | 0.11 |
| anthraquinone | | | |
| 1,5-bis((4-methylphenyl) | — | 0.01 | — |
| amino) anthraquinone | | | |
| 1,8-bis(cyclohexylamino) | — | — | 0.09 |
| anthraquinone | | | |

The discs were then laser marked using the second harmonic of a 1,064 nm YAG laser to create circular patterns of broken lines concentric with the hub of the disc. Different combinations of laser frequency, power, and speed, were used to control the extent of marking of the discs. The frequencies were 1, 5, 10, 20, and 30 kHz, currents were 5, 10, 20, 30 amperes (A), and speed was 50 millimeters per second (mm/s). Discs made from Formulations B and C were laser marked with the second harmonic of the 1,064 nm YAG laser with the above combination of frequency, power, and speed.

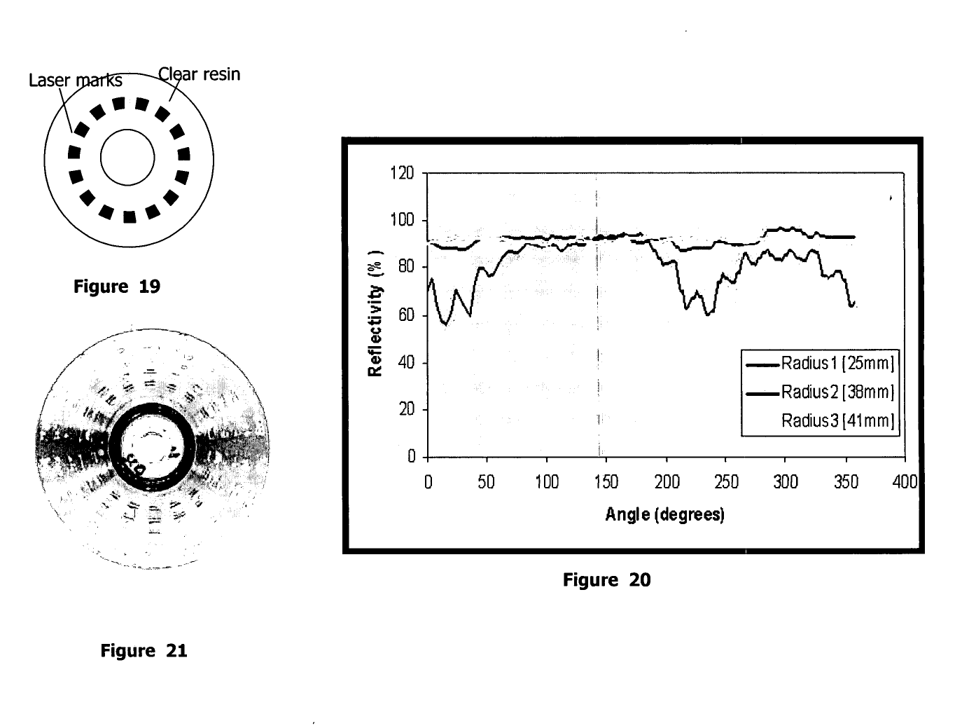

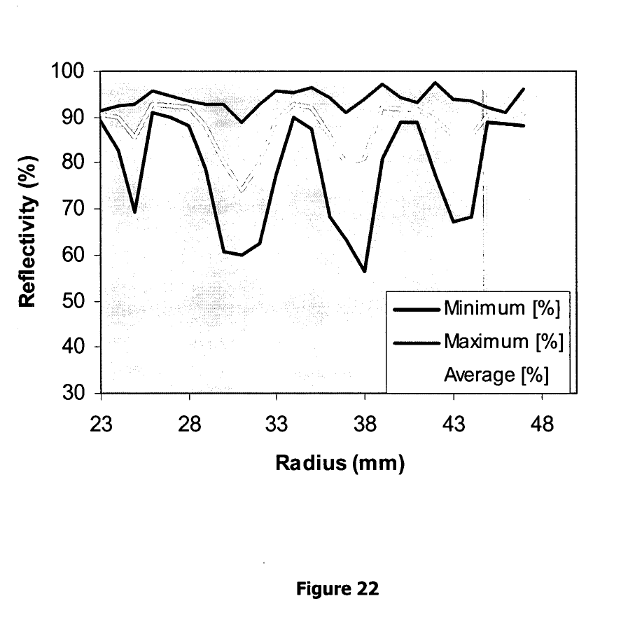

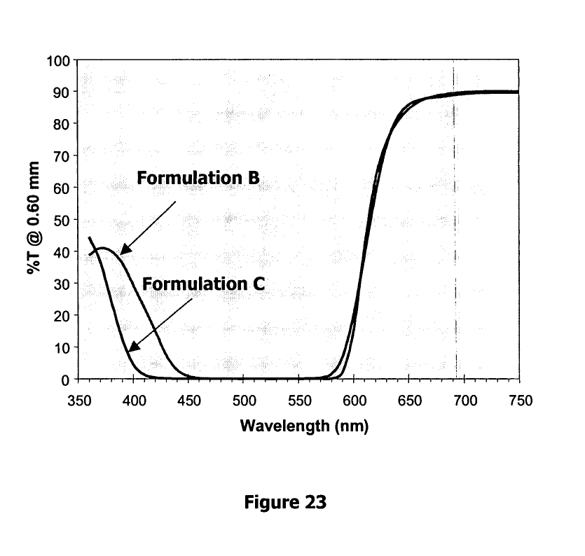

FIG. 19 shows a schematic pattern marked on a clear disc (Formulation A) and FIG. 20 illustrates the resulting reflectivity measured on a Dr. Schenk PROmeteus 146. Reflectivity of the disc was measured at three radii (25, 38, and 41 mm), and plotted as a function of angular position on the disc. The reflectivity from unmarked areas of the disc averaged 90% as can be seen from the data at radii of 25 and 41 mm. Laser marking along concentric broken circles at a radius of 38 mm caused periodic changes in reflectivity, varying from a minimum of 56% to 90% again in the unmarked regions. This drop in reflectivity is mainly due to permanent damage caused by the marking laser to the metallization layer. This example illustrates the technique of laser marking where the metal layer is damaged as observed from the burn marks from both the read side and the non-read side of the disc. Reflectivity gradients are also observed across the length of the mark. FIG. 22 illustrates variation in reflectivity obtained radially across the disc due to the light-mark pattern. As can be seen, different combinations of frequency and power can be used to tailor the reflectivity drop compared to the unmarked surface. In all cases however, there is permanent damage caused to the reflective layer. In addition to the damage to the reflective layer, another disadvantage is the fact that the surface of the disc gets disfigured as shown in FIG. 21. The laser marking creates visible black defects on the disc accompanied by stains and bubbles around the marked areas which extend into the unmarked regions. This could potentially render the disc defective and unsuitable for data read-back in players or drives commonly found in the marketplace.

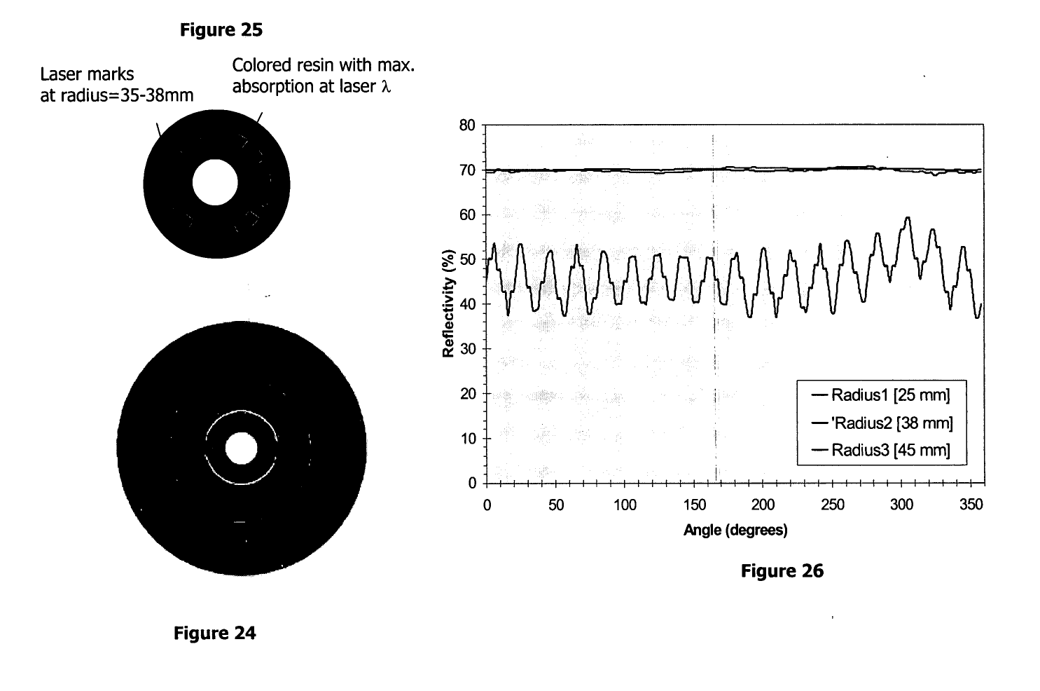

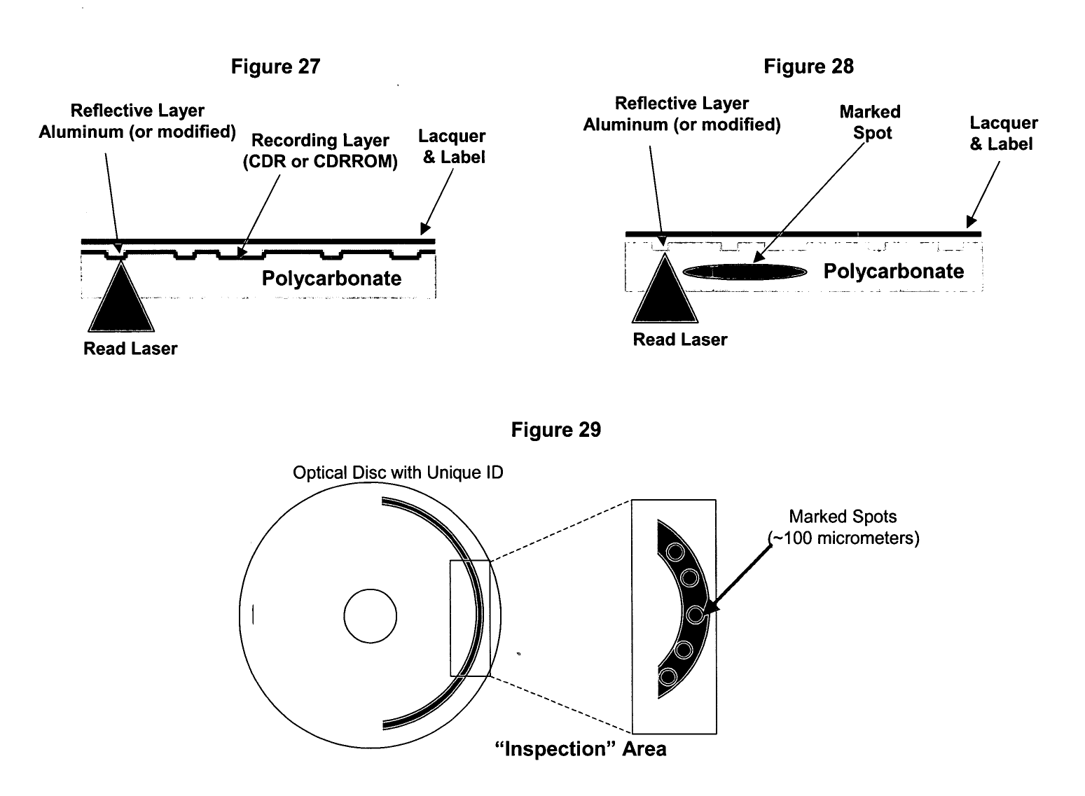

These disadvantages of the technique used with Formulation A can be overcome by incorporating a light-marking additive (e.g., having an absorption maximum at the marking laser wavelength) into the resin used to mold the disc substrate. Formulations B and C were specially formulated to have maximum absorption at 532 nm as shown in FIG. 24 (transmission spectra of color chips of 0.6 mm, measured on a Gretag-Macbeth 7000 Color Eye Spectrophotometer). FIG. 25 shows the effect of laser marking on DVDs made from Formulation B, marked with the pattern illustrated in FIG. 24. It is immediately evident from the picture that discs made from Formulation B do not exhibit the damages seen on the clear discs. Even though the laser marks are almost invisible and are free of the staining, black marks, and bubbles seen in the case of the discs of Formula A, the efficiency of the marking is not hindered, as seen in reflectivity data measured along the concentric light-marked pattern on the PROmeteus 146. Optical microscopy observations also indicate that the metal layer is not damaged and the changes in reflectivity are due to laser marks formed in the polycarbonate layer. (FIG. 26) In Formula B, the reflectivity drops along the marked pattern were periodic and showed a much more defined and sharper transition between the marked and unmarked areas.

It was surprisingly found that thermoplastic compositions (e.g., polycarbonate compositions) comprising organic dyes that absorb the marking laser energy (e.g., greater than or equal to about 99% of the marking laser energy) not only protected the metal layer (i.e., the reflective layer) from damage, but also enabled laser marking on the read side of optical discs. Such marking is detectable by a drive laser as a local change in reflectivity. The combination of local reflectivity changes gives a sequence of more reflective and less reflective zones that can be interpreted by the drive as a code (or ID number). The laser marked areas can form code encrypting a certain amount of information (e.g., 256 or 512 bits of data). The uniqueness of this code, and of the method used to form it, provides interesting features in terms of copy protection.

### Example 9

### Light-Marked Metalized CDs and Unmetalized Substrates

Compact Discs were prepared using a red polycarbonate (Formulation B as described in the example above). The samples were light-marked with a frequency-doubled Nd:YAG laser with a pulse-rate of 2.5 kHz to create substantially circular laser marks ranging in diameter from about 150 to 300 micrometers. The light-marking time was varied from 0.05 seconds (sec) to 1.0 seconds. Additionally, unmetalized red polycarbonate CD substrates were molded and light-marked using the same laser under similar conditions. With both the metalized red CDs and unmetalized red substrates, the spots were clearly visible in the polycarbonate substrate. When the metalized CDs were examined from the label-side of the disc (the side that had been metalized and lacquered) the spots were not visible. This suggests that the actual laser mark was in the polycarbonate substrate of the CD and not in the metalized layer. Furthermore, with both the CDs and unmetalized substrates, the spot size created at a particular light-marking time was substantially the same, indicating that the presence of the metallization layer in the CDs had little impact on the rate of formation of the light-marks in the CDs. Table 6 summarizes the light-marking time and spot size data for the red CDs and substrates.

TABLE 6

| | Light-marking | Spot Size |
|---|---|---|
| Sample | Time (sec) | (micrometers) |
| Red Unmetalized Substrate | 0.05 | 145 |
| Red Unmetalized Substrate | 0.2 | 185 |
| Red Unmetalized Substrate | 1.0 | 250 |
| Red Metalized CD | 0.05 | 148 |
| Red Metalized CD | 0.2 | 206 |
| Red Metalized CD | 1.0 | 280 |

CDs were prepared using a colorless polycarbonate (Formulation A as described in Example 8 above). The samples were light-marked with the pulsed laser described in the example above. However, it was found that to create laser marks in the colorless polycarbonate discs of the present example, substantially longer light-marking times were necessary. To create a similarly sized spot with the same laser power, the laser marking time was increased from 0.05 sec in the case of the metalized red CD to 0.2 sec in the case of a metalized colorless CD (4 times as long). In addition, the quality of the spots was poor; specifically, the spots were generally non-circular and there were black marks and bubbles. The laser marks were generally of the same poor quality as the marks made in the colorless discs described in Example 8. Furthermore, when the CDs were examined from the label-side of the disc (the side that had been metalized and lacquered) the spots were visible. This suggests that the laser actually created a mark in the metalized layer, in contrast to what was observed with the red metalized CDs described above.

Unmetalized colorless polycarbonate substrates were molded and light-marked using the same laser. However, at the constant laser power, the light-marking time was increased to 5 sec to create a similarly-sized spot as in the metalized colorless polycarbonate CD samples. Under these conditions, a light-mark was created in the polycarbonate substrate. These experiments suggest that when colorless polycarbonate CDs are light-marked under the conditions described here, the mark generally is formed in the metallization layer, though some marks can form in the polycarbonate substrate under high laser power or after high light-marking times. Furthermore, the results with the colorless samples indicate that the spot sizes created at a particular light-marking time are substantially larger when the metallization layer is present. This is in contrast to the results of the red samples shown above. Table 7 summarizes the light-marking time and spot size data for the colorless CDs and substrates.

TABLE 7

| | Light-marking | Spot Size |
|---|---|---|
| Sample | Time (sec) | (micrometers) |
| Colorless Unmetalized Substrate | 0.2 | 78 |
| Colorless Unmetalized Substrate | 1.0 | 111 |
| Colorless Unmetalized Substrate | 5.0 | 137 |
| Colorless Metalized CD | 0.2 | 142 |
| Colorless Metalized CD | 1.0 | 243 |
| Colorless Metalized CD | 5.0 | 333 |

### Example 10

### Thermal Stability of Photoacid Generators

The relative thermal stability of eight photoacid generators (PAGs) was evaluated to determine their ability to withstand the injection molding temperatures typically used for molding BPA-polycarbonate resin (i.e., temperatures much greater than 260° C.). The photoacid generators (0.00012 moles) were dissolved in 5 wt % Lexan 101 (BPA-polycarbonate) in methylene chloride with an equal molar amount of crystal violet lactone (0.00012 moles). Crystal violet lactone is a pH indicator that changes from colorless to blue in the presence of acid. The solutions were cast onto glass plates and the solvent was evaporated to form clear colorless polycarbonate films containing the dye (CVL) and the photoacid generator. Each of the eight photoacid generators was then screened for thermal stability.

The films were placed on a 250° C. hot stage for 30 seconds and monitored for the development of blue color, which would indicate the formation of acid from the corresponding photoacid generator (i.e., thermal decomposition of the photoacid generator). The generation of colors other than blue also indicates an incompatibility of the photoacid generator-dye-polymer system at elevated temperature.

When the themal treatment was complete, the films were exposed to ultraviolet (UV) radiation from a mercury (Hg) Flash lamp for 20 seconds. The color of the films after the thermal and UV exposure are noted in Table 8. Formation of blue color after UV exposure indicates that the photoacid generator-dye-polymer system was not damaged by the thermal treatment.

TABLE 8

| | | Color of |
|---|---|---|
| | Color of | Polymer |
| | Polymer Film | Film after |
| | after 30 | 20 seconds |
| | seconds at | of UV |
| Photoacid generator | 250° C. | exposure |
| 1,2,3-trihydroxybenzene | Colorless | Light blue |
| tris-phenylsulfonylester | | |
| Diphenyloidonium hexafluorophosphate | Blue | Blue |
| Triarylsulfonium hexafluorophosphate | Blue | Blue |
| salts, mixed (Aldrich catalog number | | |
| 407216) | | |
| N-hydroxy-5-norborne-2,3-dicarboximide | Orange-brown | Orange- |
| perfluoro-1-butanesulfonate | | brown |
| Bis(4-tert-butylphenyl)iodonium | Light blue- | Light blue- |
| p-toluensulfonate | green | green |
| Diphenyliodinium-9,10- | Blue-green | Blue-green |
| dimethoxyanthracene-2-sulfonate | | |
| Tris(4-tert-butylphenyl)-sulfonium triflate | Dark blue | Dark blue |
| 2-(4-methoxystyryl)-4,6-bis(trichloro- | Orange-brown | Orange- |
| methyl)-1,3,5-triazine | | brown |
| Blank - no PAG (only CVL + Lexan 101) | Colorless | Colorless |

As can be seen from Table 8, many photoacid generators are not stable at temperatures of greater than or equal to about 250° C. Of the photoacid generators tested, the only photoacid generator stable at such temperatures was 1,2,3-trihydroxybenzene tris-phenylsulfonylester. Due to the stability of the 1,2,3-trihydroxybenzene tris-phenylsulfonylester, this photoacid generator was further tested. It was discovered that the 1,2,3-trihydroxybenzene tris-phenylsulfonylester was able to withstand temperatures of 370° C. during DVD injection molding (e.g., exposure to 370° C. for about 3 to about 5 seconds in relatively anaerobic conditions).

The disclosed process enables the production of storage medium with unique identifiers disposed within the substrate. A mark (e.g., identifier) can be placed in the substrate without damaging the metallization of the media. Additionally, in some embodiments, the substrate can be formed by injection molding at high temperatures, e.g., wherein the thermoplastic is injected at a temperature of greater than or equal to about 275° C., or, more specifically, at a temperature of greater than or equal to about 300° C., or, even more specifically, at a temperature of greater than or equal to about 350° C.

Additionally, since these identifiers are within the substrate, they are difficult, if not impossible to remove without permanent damage to the medium. When the unique identifiers correspond to errors, they are more difficult to replicate during copying of a medium onto a recordable disc. Since these identifiers can be authenticated by standard drive systems (legacy drives), the use of counterfeit copies by the system can be prevented by incorporating software into the drives and/or servers.

The presence of an unique identifier on the disc can be used for product authentication. The ID can be analyzed by a piece of computer code resident on the disc or on a server (Internet or Intranet). Verification of the ID can be made against reference(s) algorithm(s), and/or the like, that could be locally stored or stored in a database (accessible via the Internet or Intranet). Failure to authenticate the ID can result in the denial of access to the software, stop the installation, shut down the machine, send a signal (e.g., via the internet) to the manufacturer about the existence of the copy, and/or the like. The ID can also be used to determine the number of times a particular disc has been employed to install software and to determine if that number of times exceeds a desired limit. If the number is less than or equal to a desired limit, the read device can be signaled to install the software, while, if the number is greater than a desired limit, the read device can be signaled to signal an error.

Desirably computer code performing the authentication has anti-hacking features (memory protection, encryption, protection against hacking tools and software, and the like, as well as combinations comprising at least one of the foregoing). These anti-hacking features can protect the disc against applications of software patches or similar technologies designed to remove the information (e.g., code, algorithm, or the like) related to unique ID detection and authentication, and to allow for unauthorized access or installation.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A storage medium, comprising:
a substrate comprising a thermoplastic and a light-mark formed from at least a portion of light-marking additive that was mixed with the thermoplastic, wherein an optical property of the light-marking additive at an optical drive read wavelength can change due to being contacted with a mark wavelength, wherein the substrate has a thickness of greater than or equal to 0.3 mm;
a reflective layer disposed on a side of the substrate; and
data.

2. The storage medium of claim 1, wherein the optical property change in the light-marking additive is irreversible.

3. The storage medium of claim 1, further comprising a recordable dye layer disposed between the substrate and the reflective layer.

4. The storage medium of claim 1, wherein the data is selected from the group consisting of pits, lands, grooves, and a combination comprising at least one of the foregoing.

5. The storage medium of claim 1, wherein a difference in reflectivity between an area of the substrate adjacent the light-mark and the light-mark is greater than or equal to about 15%.

6. The storage medium of claim 1, wherein a difference between the mark wavelength and the read wavelength is greater than or equal to about ±30 nm.

7. The storage medium of claim 6, wherein the difference is greater than or equal to about ±100 nm.

8. The storage medium of claim 1, wherein the substrate has a thickness of greater than or equal to about 0.6 mm.

9. The storage medium of claim 1, wherein the light-marking additive is selected from the group consisting of azo dye, methine dye, coumarin, pyrazolone, quinophtalone, quinacridone, perinone, anthraquinone, oxazines, anthrapyridone, Vat dye, phthalocyanine, rylene derivative, arylcarbonium dye precursor, and combinations comprising at least one of the foregoing light-marking additives.

10. The storage medium of claim 9, wherein the light-marking additive is selected from the group consisting of anthraquinone, rylene derivative, arylcarbonium dye precursor, and combinations comprising at least one of the foregoing light-marking additives.

11. The storage medium of claim 10, wherein the light-marking additive is selected from the group consisting of arylmethane, arylcarbinol, phthalein, sulfonephthalein, fluorans, and combinations comprising at least one of the foregoing light-marking additives.

12. The storage medium of claim 11, wherein the substrate further comprises a compound that locally changes the acidity of its surroundings after exposure to light and/or heat.

13. The storage medium of claim 12, wherein the compound comprises an arylsulfonate derivative.

14. The storage medium of claim 13, wherein the compound comprises 1,2,3-trihydroxybenzene tris-phenylsulfonylester.

15. The storage medium of claim 11, wherein the light-marking additive comprises crystal violet lactone.

16. The storage medium of claim 10, wherein the light-marking additive is selected from the group consisting of 1,5-anthraquinones, 1,4-anthraquinones, 1,8-anthraquinones, anthrapyridone, and combinations comprising at least one of the foregoing light-marking additives.

17. The storage medium of claim 1, wherein the light-marking additive is selected from the group consisting of methyl green, organica dye, tetrazolium blue chloride, benzoyl leuco methylene blue, (4-{cyano[4-(dibutylamino)phenyl]methylene}cyclohexa-2,5-dien-1-yl)malononitrile, IR786 iodide, 2-[2-[2-Chloro-3-[2-(1,3-dihydro-1,3,3-trimethyl-2H-indol-2-ylidene)-ethylidene]-1-cyclohexen-1-yl]-ethenyl]-1,3,3-trimethyl-3H-indolium chloride, IR780 iodide, copper phthalocyanines, and combinations comprising at least one of the foregoing light-marking additives.

18. The storage medium of claim 1, wherein the thermoplastic comprises optical quality polycarbonate.

19. The storage medium of claim 1, wherein the substrate further comprises a photoacid generator comprising a sulfonate derivative of the formula R₃SO₂OR₄, wherein R₃ is selected from the group consisting of an alkyl, aryl, and a perfluoroalkyl group, and wherein R₄ comprises an aryl group.

20. The storage medium of claim 1, wherein the light-mark is capable of being detected with a legacy drive.

21. The storage medium of claim 1, wherein the light-mark is disposed in a mastered data groove.

22. The storage medium of claim 1, wherein the reflective layer on the substrate with the light-mark, does not have any damage visible to the human eye.

23. The storage medium of claim 1, wherein the light-mark is capable of being detected as a change in the data.

24. A method for making a storage medium, comprising:
combining a thermoplastic with a light-marking additive to form a blend;
injection molding the blend to form a substrate;
disposing a reflective layer on the substrate to form a medium; and
exposing a portion of the substrate to a marking wavelength to form a light-mark in the substrate.

25. The method of claim 24, further comprising combining a photoacid generator with the optical quality polycarbonate and the light-marking additive.

26. The method of claim 24, further comprising forming pits and lands in a surface of the substrate, between the substrate and the reflective layer.

27. The method of claim 24, wherein the reflective layer on the substrate with the light-mark, does not have any damage visible to the human eye.

28. The method of claim 24, wherein the blend, when injection molded, is initially at a temperature of greater than or equal to about 275° C.

29. The method of claim 28, wherein the temperature is greater than or equal to about 350° C.

30. A method for using a storage medium, comprising,
directing a reading device to detect an inspection area of the storage medium, and wherein the inspection area on an authentic medium has a light-mark in a substrate of the storage medium that forms an optically induced signature;
converting the optically induced signature to a digital identification signature; and
verifying the authenticity of the digital identification signature.

31. The method of claim 30, further comprising:
sending the digital identification signature to a central database; and
checking the central database to determine the number of times the storage medium has previously been used for installation of software; and
if the number of times is less than or equal to a desired limit, signaling the reading device to install the software.

31. The method of claim 30, wherein, if the reading device is signaled to install, further comprising updating the central data base that this storage medium has been used for installation.

32. The method of claim 30, further comprising, if the number of times is greater than the desired limit, signaling the reading device to signal an error.

33. The method of claim 29, wherein the read device is directed by data on the storage medium.

34. The method of claim 28, wherein the read device is directed by software external to the storage medium.
